(19) United States
(12) Patent Application Publication
(10) Pub. No.: US 2024/0274900 A1
(43) Pub. Date: Aug. 15, 2024

(54) stopping disasters with using advanced physics.

(71) Applicant: Menni Menashe Zinger, Ashkelon (IL)

(72) Inventor: Menni Menashe Zinger, Ashkelon (IL)

(21) Appl. No.: 18/107,508

(22) Filed: Feb. 9, 2023

(51) Int. Cl. H01M 10/44; H02J 7/00

(52) U.S. Cl. CPC H01M 10/441; H02J 7/00

(57) ABSTRACT

At this invention I show ways to stop disasters from happening and save many lives and property by using advanced physics.

By using quantum mechanics and inspiration zones and model/s of a land/underground/volcano/sea/ocean/forests it is possible to stop a disaster from happening or weaken it significantly and may be to give alerts days or weeks before in order to prepare to the disaster or run away for some time or forever from an area that's by diluting the earthquake waves and the energy that absorbed at the ground under even many kilometers under and by that to stop an earthquake from happening and diluting lava/magma at volcano and or diluting tsunami waves until it would be harmless to people and property and the great energy that gloomed inside a tsunami waves would be diluted or used at other place as energy for electric supply also the energy at earthquake waves can be used for electric supply by transfer it into kinetic electric devices and batteries/absorbing devices by using springs at great scales that can move wheels and charge batteries with their spinning movement. and the energy that is being created by contact of two tectonic board at comfortable time before or at exact timing by using time machines and using the energy for electricity supply Kinetic electric devices and using springs at size of few meters or 10-30 meters in order to absorb the vibrations and make it electric as at watches from kinetic kinds or by spinning wheels connected to the springs and maybe joints connected that would fill batteries next to them or at some distance the spinning wheels create electric field that fill the electric cells and cause electrons to move between the opposite polls and there is an electric current at that way from earthquake center to absorb devices kinetic once at minimized ratio at great scales as 1: trillion see claim 1 at my invention time machine and dilute the energy waves of earthquakes into weak once before, dilute magnetic/kinetic waves The dilute of earthquake waves would be done by inspiring on them a fixed object without waves or air or vacuum or steady land Using dilute of eruption of volcano or cooling it or dilute of tsunami in order to stop a disaster from happening

Using Time Machine alert in order to evacuate population people and animals and property from a place before disaster as earthquakes/tsunami/volcano days before.

1. Using the energy that gloomed at earthquake in order to pass it into kinetic device/s at minimized ratio of 1:1 million, 1:1 billion, 1:1 quadrillion, 1:100 quadrillion By using quantum mechanics and inspiration zones and model/s and diluting the energy/kinetic waves that put in danger the population and structures and using inspiration zones and quantum mechanics and model/s by inspiring on the earthquake center steady land/ground or air on tsunami or vacuum on tsunami or air inside volcano/or water inside volcano and in order to not waste energy and use it to the benefit of people, as it used at launching, see claim 1 at my invention number 266246.il.2019. and from 100% energy into almost zero % energy level and passing the energy by magnetic/electro magnetic/radio waves/t.v waves/micro waves pneumatic device/hydraulic device and inspiration zones connected by same frequencies and thickening/increasing power into 1-100% or more at chargers and batteries and kinetic springs by the absorbing ability of operators and their needs of energy and at the comfortable ratio, 1:1 million, 1:1 billion, 1 100 billion, 1:1 triliard, 1:1 quadrillion that are connected to chargers and batteries and absorbing devices the energy absorbed at earthquake/tectonic boards that in the focus of an earthquake and inspiring the energy directly on batteries and charging them by the energy of an earthquake and or tsunami or volcano by using wires that would get hot by the volcano heat and change the heat into electric energy and go to batteries and chargers and from there into the electric net of the country/cities, industrial areas/offices
